(19) United States
(12) Patent Application Publication
(10) Pub. No.: US 2010/0030804 A1
(43) Pub. Date: Feb. 4, 2010

(54) Synchronization of Locations in Real and Virtual Worlds

(75) Inventors: Derick G. Behrends, Rochester, MN (US); Zachary A. Garbow, Rochester, MN (US); Travis R. Hebig, Rochester, MN (US); Daniel M. Nelson, Rochester, MN (US); Jesse D. Smith, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: INTERNATIONAL BUSINESS MACHINES CORPORATION, Armonk, NY (US)

(21) Appl. No.: 12/183,283

(22) Filed: Jul. 31, 2008

(51) Int. Cl. G06F 17/30

(52) U.S. Cl. 707/103 R; 707/E17.009

(57) ABSTRACT

Embodiments of the invention provide techniques for synchronizing virtual locations to real locations. In one embodiment, data sources are monitored to detect events that affect real locations. A filter specified by an owner of the virtual location may be used to detect keywords indicating events affecting a particular location. In the event that such events are detected, the owner may be notified to modify the virtual location to match the real location. Optionally, the virtual location may be automatically modified to match the real location.

### BACKGROUND OF THE INVENTION

1. Field of the Invention

Embodiments of the invention relate to immersive virtual environments. More specifically, embodiments of the invention relate to synchronizing locations of the real world with locations of an immersive virtual environment.

2. Description of the Related Art

A virtual world is a simulated environment in which users may inhabit and interact with one another via avatars. Users may also interact with virtual objects and locations of the virtual world. An avatar generally provides a graphical representation of an individual within the virtual world environment. Avatars are usually presented to other users as two or three-dimensional graphical representations of humanoids. Frequently, virtual worlds allow for multiple users to enter and interact with one another. Communication may be in the form of text messages sent between avatars, but may also include real-time voice communication.

Virtual worlds provide an immersive environment as they typically appear similar to the real world, with real world rules such as gravity, topography, locomotion, real-time actions, and communication. Further, virtual worlds may include locations modeled on actual locations of the real world. Such virtual locations may be modeled to have similar features to the actual locations, including geography, landscapes, streets, buildings, and the like.

Virtual worlds may be persistent. A persistent world provides an immersive environment (e.g., a fantasy setting used as a setting for a role-playing game) that is generally always available, and world events happen continually, regardless of the presence of a given avatar. Thus, unlike more conventional online games or multi-user environments, the plots and events continue to develop even while some of the players are not playing their characters.

### SUMMARY OF THE INVENTION

One embodiment of the invention includes a computer-implemented method. The method generally includes: collecting, from at least one data source, data describing one or more events occurring in the physical world, wherein the at least one data source matches one or more predefined characteristics specified in a stored data filter; and determining, based on the collected data, at least one real location, of the physical world, affected by the one or more events. The method may also include, upon determining that at least one real location matches one or more predefined characteristics specified in a stored data filter: identifying at least one location of a virtual world modeled according to the at least one real location; and performing one or more actions to synchronize the at least one location of a virtual world with the at least one real location.

Another embodiment of the invention includes a computer-readable storage medium containing a program, which when executed on a processor performs an operation. The operation may generally include: collecting, from at least one data source, data describing one or more events occurring in the physical world, wherein the at least one data source matches one or more predefined characteristics specified in a stored data filter; and determining, based on the collected data, at least one real location, of the physical world, affected by the one or more events. The operation may also include, upon determining that at least one real location matches one or more predefined characteristics specified in a stored data filter: identifying at least one location of a virtual world modeled according to the at least one real location; and performing one or more actions to synchronize the at least one location of a virtual world with the at least one real location.

Still another embodiment of the invention includes a system having a processor and a memory containing a program, which when executed by the processor is configured to perform an operation. The operation may generally include: collecting, from at least one data source, data describing one or more events occurring in the physical world, wherein the at least one data source matches one or more predefined characteristics specified in a stored data filter; and determining, based on the collected data, at least one real location, of the physical world, affected by the one or more events. The operation may also include, upon determining that at least one real location matches one or more predefined characteristics specified in a stored data filter: identifying at least one location of a virtual world modeled according to the at least one real location; and performing one or more actions to synchronize the at least one location of a virtual world with the at least one real location.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram that illustrates a client server view of computing environment, according to one embodiment of the invention.

FIGS. 2A-2B illustrate a user display for a user participating in a virtual world, according to one embodiment of the invention.

FIG. 3 is a flow diagram illustrating a method for creating a location filter for synchronizing a virtual world, according to one embodiment of the invention.

FIG. 4 is a flow diagram illustrating a method for synchronizing a virtual world to the real world, according to one embodiment of the invention.

FIG. 5 is a flow diagram illustrating a method for analyzing image data to detect changes to real locations that affect locations within a virtual world, according to one embodiment of the invention.

### DETAILED DESCRIPTION OF THE PREFERRED EMBODIMENTS

A virtual world may include virtual locations (i.e., terrain, streets, buildings, houses, etc.) that are modeled on real-world locations. For example, a virtual world may include an accurate replica of a real location for use in architectural design, marketing, etc. Such virtual locations may provide, e.g., a view from the balcony of a particular room at a hotel, a view of a house for sale, and the like. However, in some situations, the real-world location may be changed, or may be affected by changes to other parts of the virtual world. For example, the view from a window may be obstructed by a new building across the street. In another example, the exterior of a house may be changed by the construction of an addition. In such situations, there may be a need to synchronize the virtual location to the changed or affected real-world location.

Embodiments of the invention provide techniques for synchronizing virtual locations to real locations. In one embodiment, data sources are monitored to detect events that affect real locations. A filter specified by an owner of the virtual location may be used to detect keywords indicating events affecting a particular location. In the event that such events are detected, the owner may be notified to modify the virtual location to match the real location. Optionally, the virtual location may be automatically modified to match the real location.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive and DVDs readable by a DVD player) on which information is permanently stored; and (ii) writable storage media (e.g., floppy disks within a diskette drive, a hard-disk drive or random-access memory) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

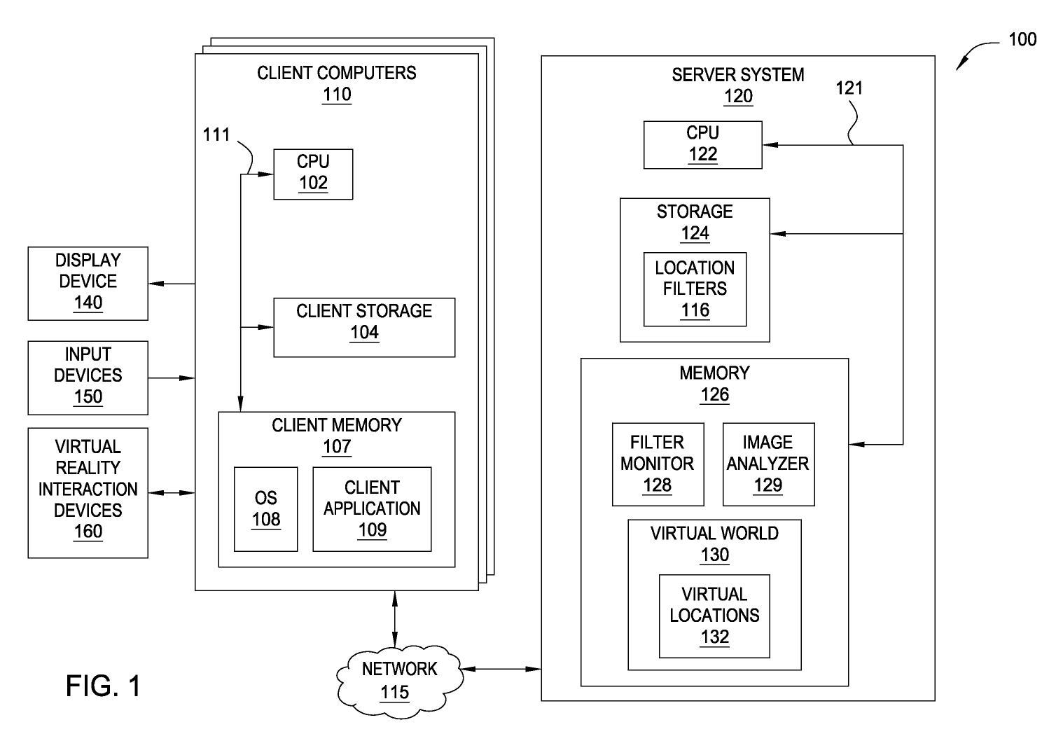

FIG. 1 is a block diagram that illustrates a client server view of computing environment 100, according to one embodiment of the invention. As shown, computing environment 100 includes client computers 110, network 115 and server system 120. In one embodiment, the computer systems illustrated in environment 100 may include existing computer systems, e.g., desktop computers, server computers, laptop computers, tablet computers, and the like. The computing environment 100 illustrated in FIG. 1, however, is merely an example of one computing environment. Embodiments of the present invention may be implemented using other environments, regardless of whether the computer systems are complex multi-user computing systems, such as a cluster of individual computers connected by a high-speed network, single-user workstations, or network appliances lacking non-volatile storage. Further, the software applications illustrated in FIG. 1 and described herein may be implemented using computer software applications executing on existing computer systems, e.g., desktop computers, server computers, laptop computers, tablet computers, and the like. However, the software applications described herein are not limited to any currently existing computing environment or programming language, and may be adapted to take advantage of new computing systems as they become available.

As shown, each client computer 110 includes a central processing unit (CPU) 102, which obtains instructions and data via a bus 111 from client memory 107 and client storage 104. CPU 102 is a programmable logic device that performs all the instruction, logic, and mathematical processing in a computer. Client storage 104 stores application programs and data for use by client computer 110. Client storage 104 includes hard-disk drives, flash memory devices, optical media and the like. Client computer 110 may be connected to the network 115.

Client memory 107 includes an operating system (OS) 108, a client application 109 and a browser application 119. Operating system 108 is the software used for managing the operation of the client computer 110. Examples of OS 108 include UNIX, a version of the Microsoft Windows® operating system, and distributions of the Linux® operating system. (Note, Linux is a trademark of Linus Torvalds in the United States and other countries.)

In one embodiment, client application 109 provides a software program that allows a user to connect to a virtual world 130 (included in server system 120), and once connected, to explore and interact with virtual world 130. Further, client application 109 may be configured to generate and display a visual representation of the user within the immersive environment, generally referred to as an avatar. The avatar of the user is generally visible to other users in the virtual world, and the user may view avatars representing the other users. The client application 109 may also be configured to generate and display the immersive environment to the user and to transmit the user's desired actions to virtual world 130. Such a display may include content from the virtual world determined from the user's line of sight at any given time. For the user, the display may include the avatar of that user or may be a camera eye where the user sees the virtual world through the eyes of the avatar representing this user.

In one embodiment, server system 120 includes a CPU 122, which obtains instructions and data via a bus 121 from memory 126 and storage 124. The CPU 122 could be any processor adapted to support the methods of the invention. The memory 126 is any memory sufficiently large to hold the necessary programs and data structures. Memory 126 could be one or a combination of memory devices, including Random Access Memory, nonvolatile or backup memory, (e.g., programmable or Flash memories, read-only memories, etc.). Storage 124 includes hard-disk drives, flash memory devices, optical media and the like. In addition, memory 126 and storage 124 may be considered to include memory physically located elsewhere in a server 120, for example, on another computer coupled to the server 120 via bus 121. Server 120 may be operably connected to the network 115, which generally represents any kind of data communications network. Accordingly, the network 115 may represent both local and wide area networks, including the Internet.

Memory 126 includes virtual world 130. In one embodiment, virtual world 130 may be a software application that allows a user to explore and interact with an immersive virtual environment. Illustratively, virtual world 130 includes virtual locations 132. Virtual locations 132 may be locations modeled within virtual world 130, and may represent terrain, buildings, streets, structures, and the like.

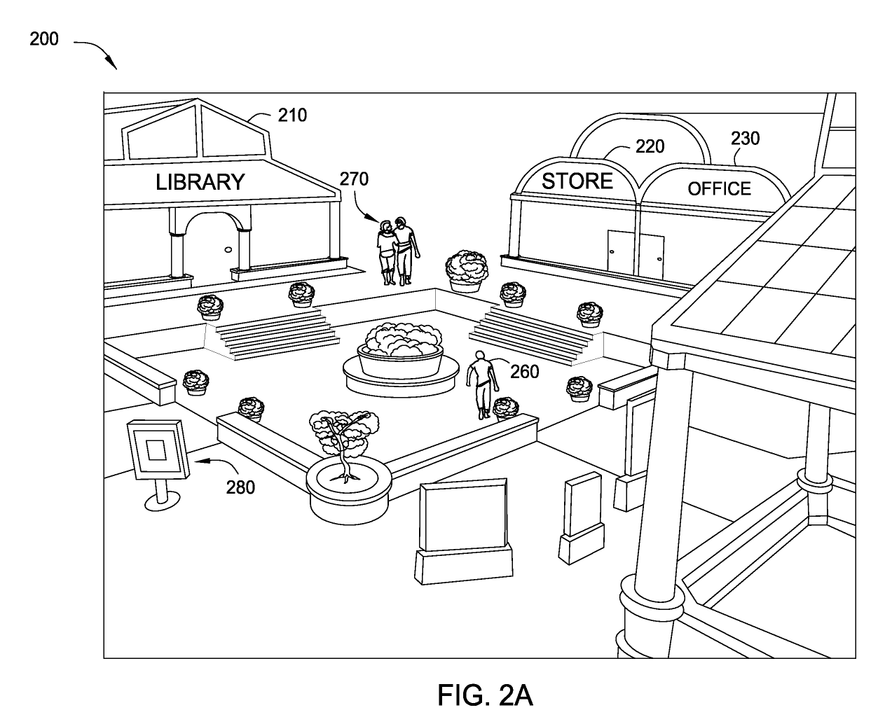

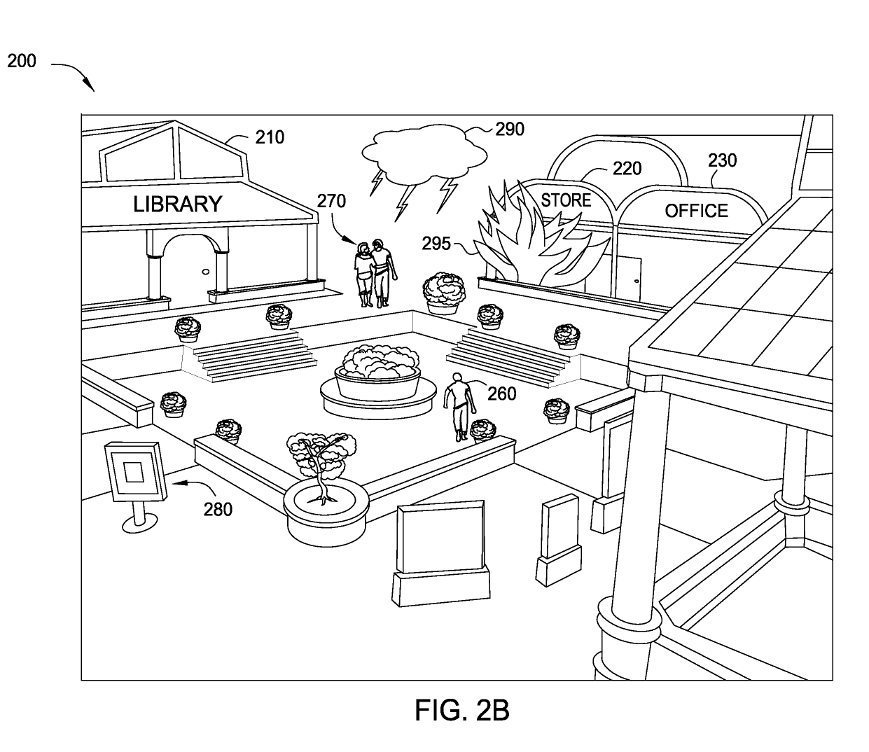

FIG. 2A illustrates a user display 200 of a virtual location, according to one embodiment of the invention. In this example, the user display 200 presents a “third-person” view, meaning the user is represented by an avatar 260 that is visible within the user display 200. As shown, user display 200 is displaying a view of a town square, representing an example of a virtual location 132 included in the virtual world 130. Thus, the user display 200 shows features included in the virtual location 132, including a store 220, an office 230, a library 210 and a kiosk 280. The user display 200 also includes a pair of avatars 270 of other users of the virtual world 130. The user may interact with elements displayed in user display 200. For example, the user may interact with kiosk 280 by operating controls built into the kiosk 280, requesting information, etc. The user may also enter the store 220 or the office 230. As described, the virtual location 132 shown in the user display 200 may be modeled on an actual location within the real world. Of course, the virtual location 132 shown in FIG. 2 is merely an example. The virtual world 130 may include any number and type of virtual locations 132. For example, the store 220, office 230 and library 210 may also be considered to be virtual locations 132.

Referring again to FIG. 1, memory 126 also includes filter monitor 128 and image analyzer 129. In one embodiment, the filter monitor 128 may be a software application configured to monitor data sources for indications of changes to real locations that affect virtual locations 132. The filter monitor 128 may search for data matching a set of location filters 116 included in storage 124, thus indicating that specified locations have been affected.

In one embodiment, each location filter 116 may be a data structure specifying data sources and keywords to monitor with respect to a particular real location. For example, a user may create a location filter 116 to specify data sources to be monitored, such as web pages, newswires, construction announcements, realty databases and the like. Further, the location filter 116 may specify keywords to indicate changes to a real location, such as “new building,” “construction,” “demolition” and the like. Furthermore, the location filter 116 may specify a real world location that may be affected. The location may be specified as a street address (e.g., “1121 Main Street”), as map coordinates (e.g., X latitude and Y longitude), as a named area (e.g., “west Baltimore,” “Central Park,” etc.), or by other techniques.

In one embodiment, each location filter 116 may include commands for actions to be performed in response to detecting a change to a real world location. For example, the location filter 116 may specify that, in response to detecting a given keyword, an email notification should be sent to the owner of the virtual world location. The email notification may prompt the owner to update the virtual location 132. Additionally, the location filter 116 may specify instructions to allow the filter monitor 128 to perform automatic updates to the virtual location 132 to match the change to the real location. For example, the location filter 116 may specify that, upon detecting that a structure present at a real location is removed, the filter monitor 128 may modify the virtual location 132 by deleting the virtual version of the removed structure.

In one embodiment, the filter monitor 128 may be configured to detect temporary or emergency events affecting a real location. Additionally, the filter monitor 128 may be further configured to automatically modify the virtual location 132 to alert users of the virtual world 130. For example, a building may be temporarily affected by a fire, a city may be affected by a severe weather event (e.g., tornado, hurricane, etc.), a street may become blocked by severe traffic or a parade, and the like. In such situations, in one embodiment, a virtual property 132 may be updated to display an indicator of the temporary condition affecting the real property.

FIG. 2B illustrates a user display 200 of a virtual location 132 having indicators of temporary or emergency events, according to one embodiment of the invention. As shown, the virtual location 132 is displayed in user display 200 as including a storm indicator 290, and the store 220 is displayed with a fire indicator 295. In one embodiment, the storm indicator 290 may be a graphic indicator (e.g., symbol, text, color, visual effect, etc.) that communicates the current presence of a storm at the real location corresponding to the virtual location 132. Similarly, the fire indicator 295 may be a graphic indicator communicating that the real store corresponding to the store 220 is currently on fire. Such graphic indicators may be used to enable users of a virtual world to be aware of temporary conditions in the real world that may affect them. For example, a user of virtual world 130 may see graphic indicators (not shown) in user display 200 that indicate that a real highway is under heavy traffic conditions, and that a real road is blocked by a parade. In one embodiment, indicators of temporary conditions may be presented to all users present in a virtual location 132. Alternatively, users may configure a location filter 116 to only allow visibility of indicators for specific temporary conditions, or may choose to configure the client application 109 to exclude any displays of indicators.

Referring again to FIG. 1, in one embodiment, the image analyzer 129 may be a software application configured to analyze image data to detect changes to real locations that affect virtual locations 132. For example, the image analyzer 129 may compare images of a real location taken at two points in time. Such images may include, e.g., aerial photographs, satellite photographs, etc. The image analyzer 129 may then compare the images to detect any changes affecting the location. For example, the image analyzer 129 may use pattern recognition algorithms to detect changes in an image of a real location.

The user may view the virtual world using a display device 140, such as an LCD or CRT monitor display, and interact with the client application 109 using input devices 150. Further, in one embodiment, the user may interact with client application 109 and virtual world 130 using a variety of virtual reality interaction devices 160. For example, the user may don a set of virtual reality goggles that have a screen display for each lens. Further, the goggles could be equipped with motion sensors that cause the view of the virtual world presented to the user to move based on the head movements of the individual. As another example, the user could don a pair of gloves configured to translate motion and movement of the user's hands into avatar movements within the virtual reality environment. Of course, embodiments of the invention are not limited to these examples and one of ordinary skill in the art will readily recognize that the invention may be adapted for use with a variety of devices configured to present the virtual world to the user and to translate movement/motion or other actions of the user into actions performed by the avatar representing that user within virtual world 130.

Of course, the embodiments described above are intended to be illustrative, and are not limiting of the invention. Other embodiments are broadly contemplated. For example, the location filters 116 may be stored in the client storage 104. In another example, the functionality of the filter monitor 128 and/or the image analyzer 129 may be incorporated into the virtual world 130. Such modifications may be made to suit particular situations, and are thus contemplated to be in the scope of the invention.

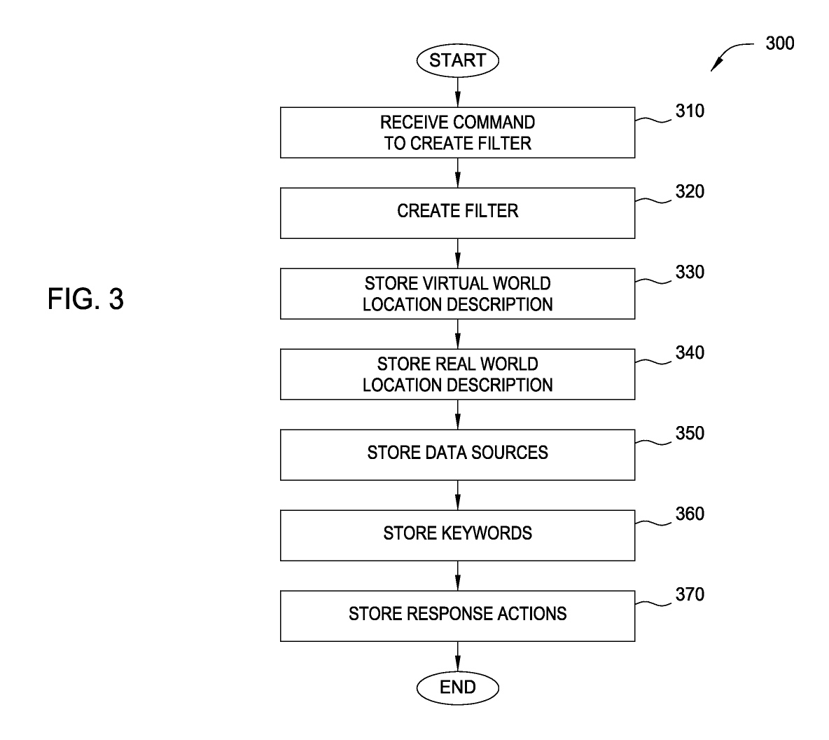

FIG. 3 is a flow diagram illustrating a method 300 for creating a location filter for synchronizing a virtual world, according to one embodiment of the invention. Persons skilled in the art will understand that, even though the method is described in conjunction with the systems of FIGS. 1-2, any system configured to perform the steps of method 300, in any order, is within the scope of the present invention.

The method 300 begins at step 310, where a command to create a location filter may be received. For example, filter monitor 128 (shown in FIG. 1) may receive a user command to create a location filter 116 configured to detect changes affecting a real world office building. The user creating the location filter 116 may be an owner (or other responsible party) of a virtual property intended to accurately replicate the real world property.

At step 320, the location filter 116 may be created. For example, a new location filter may be added to a set of location filters 116 included in storage 124. The location filter 116 may represent, e.g., an XML file, metadata, database records of a database, or any other suitable data structure. At step 330, a description of the virtual world location may be stored in the location filter 116. For example, the description of the virtual world location may be a virtual street address, a location identifier or map coordinates specified within the virtual world 130, and the like. At step 340, a description of the real world location to be monitored may be stored in the location filter 116. For example, the description of the real world location may be a real world street address, map coordinates, a named area, and the like.

At step 350, data sources may be stored in the location filter 116. For example, the location filter 116 may store web pages, newswires, construction announcements, and realty databases to be monitored. At step 360, keywords indicating changes to the real world location may be stored in the location filter 116. For example, the location filter 116 may store keywords such as “new building,” “construction,” “demolition” and the like. At step 370, commands for actions to be performed in response to detecting a change to a real world location may be stored in the location filter 116. For example, such commands may include sending a notification to the owner of the virtual world location, performing an automatic update to the virtual world location, and the like. After step 370, the method 300 terminates. Of course, method 300 is provided for illustrative purposes only, and is not limiting of the invention. It is contemplated that the steps of method 300 may be modified to incorporate other data describing real and virtual locations into location filter 116. Such modifications may be made to suit particular situations, and are thus contemplated to be in the scope of the invention.

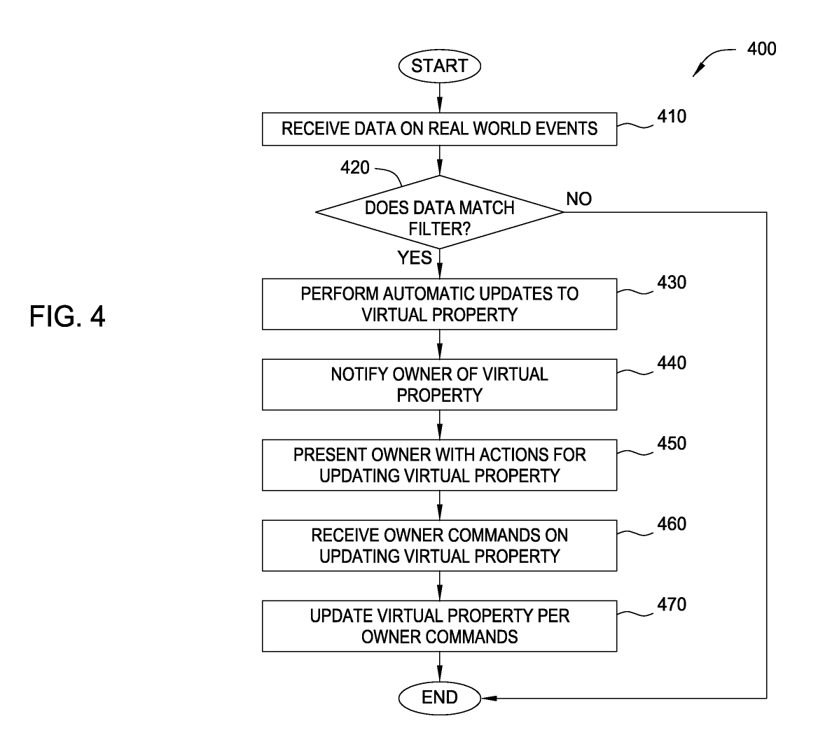

FIG. 4 is a flow diagram illustrating a method 400 for synchronizing a virtual world to the real world, according to one embodiment of the invention. Persons skilled in the art will understand that, even though the method is described in conjunction with the systems of FIG. 1, any system configured to perform the steps of method 400, in any order, is within the scope of the present invention.

The method 400 begins at step 410 by receiving data related to real world events. For example, the filter monitor 128 (shown in FIG. 1) may receive data from a news feed (e.g., an RSS feed) related to local news, realty listings, and the like. At step 420, it is determined whether the received data matches a predefined location filter. For example, the filter monitor 128 may determine whether the received data matches the requirements of a location filter 116 included in storage 124. In one embodiment, the location filter 116 may be composed according to the method 300 described above with reference to FIG. 3. If it is determined that the data does not match any location filters, then the method 400 terminates after step 420. However, if the filter monitor 128 determines that the received data matches a location filter 116, then at step 430, the filter monitor 128 may automatically update the virtual property. More specifically, the filter monitor 128 may be configured to perform automatic updates to the virtual property so that it matches the real property. For example, upon detecting that a structure present at a real location is removed, the filter monitor 128 may be configured to modify the virtual location 132 by deleting the virtual version of the removed structure.

At step 440, the filter monitor 128 may notify an owner of the virtual property. For example, the filter monitor 128 may generate an email notifying the owner of the location filter 116 that the real property has been affected. At step 450, the owner is presented with available actions for updating the virtual property. For example, the filter monitor 128 may be configured to determine how the real location has been changed, and to then determine any actions required to update the virtual location 132 to match the real location. In the case that actions are available to update the virtual location 132, the filter monitor 128 may then present the owner with the options of performing the available actions.

At step 460, owner commands on updating the virtual property may be received. For example, the filter monitor 128 may receive commands given by the owner of the location filter 116. At step 470, the owner commands may be performed to update the virtual property. For example, the filter monitor 128 may perform commands issued by the owner to update the virtual location 132. After step 470, the method 400 terminates.

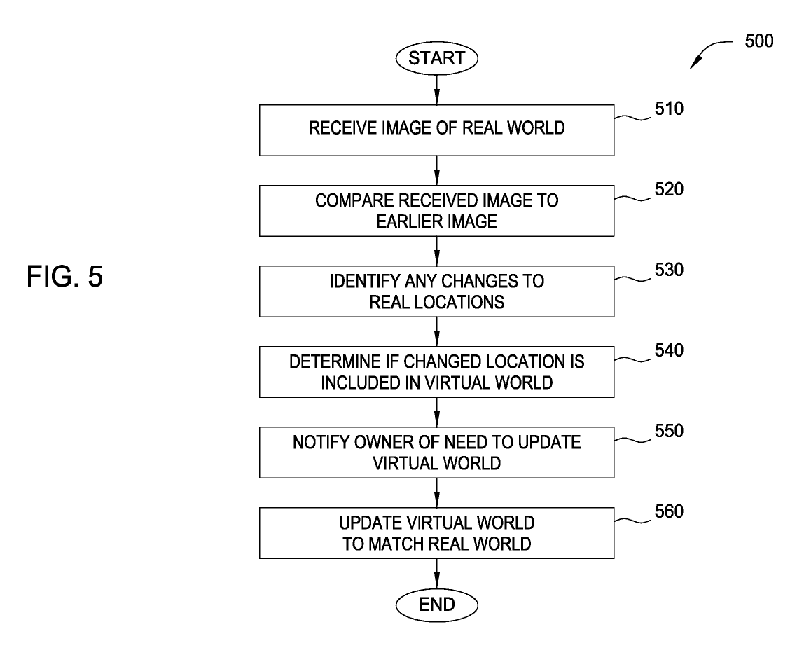

FIG. 5 is a flow diagram illustrating a method 500 for analyzing image data to detect changes to real locations that affect locations within a virtual world, according to one embodiment of the invention. Persons skilled in the art will understand that, even though the method is described in conjunction with the systems of FIG. 1, any system configured to perform the steps of method 500, in any order, is within the scope of the present invention.

The method 500 begins at step 510, where an image of the real world is received. For example, image analyzer 129 (shown in FIG. 1) may receive image data retrieved from a web site or database storing satellite images. In another example, a user may upload an aerial photograph (e.g., a photograph of a city block taken from a flying airplane) to image analyzer 129. At step 520, image analyzer 129 may compare the received image to an earlier image of the same location. At step 530, any differences between the received image and the earlier image may be used to identify changes to the real locations. For example, image analyzer 129 may be configured to identify changes to real locations included in the received image.

At step 540, image analyzer 129 may determine if any real locations determined at step 530 to have changed are represented by virtual locations 132. For example, image analyzer 129 may use a description of a real world location (e.g., street address, map coordinates, etc.) included in location filters 116 to determine if a virtual location 132 is affected by a change detected in the received image. At step 550, the owner of the affected virtual location 132 may be notified of the need to update the virtual location 132. For example, image analyzer 129 may send an email notification to an owner specified in the location filter 116. At step 560, the affected virtual location 132 may be updated to match the identified change to the real property. For example, the owner may interact with a configuration interface to change the virtual location 132. Such a configuration interface may be provided by, e.g., client application 109, image analyzer 129, virtual world 130, etc. In another example, image analyzer 129 may be configured to automatically update the virtual location 132. After step 560, the method 500 terminates.

While the foregoing is directed to embodiments of the present invention, other and further embodiments of the invention may be devised without departing from the basic scope thereof, and the scope thereof is determined by the claims that follow.

What is claimed is:

1. A computer-implemented method, comprising:
collecting, from at least one data source, data describing one or more events occurring in the physical world, wherein the at least one data source matches one or more predefined characteristics specified in a stored data filter;
determining, based on the collected data, at least one real location, of the physical world, affected by the one or more events; and
upon determining that at least one real location matches one or more predefined characteristics specified in a stored data filter:
identifying at least one location of a virtual world modeled according to the at least one real location; and
performing one or more actions to synchronize the at least one location of a virtual world with the at least one real location.

2. The computer-implemented method of claim 1, wherein performing one or more actions comprises:
determining, based on the collected data, one or more modifications to the at least one location of the virtual world required to match the at least one real location; and
performing the determined one or more modifications to the at least one location of the virtual world.

3. The computer-implemented method of claim 1, wherein the at least one data source comprises at least one of: (i) a web page, (ii) a news feed, and (iii) a database.

4. The computer-implemented method of claim 1, wherein determining that at least one real location matches one or more predefined characteristics specified in a stored data filter comprises matching words included in the collected data to one or more keywords specified in the stored data filter.

5. The computer-implemented method of claim 1, wherein the one or more predefined characteristics specified in a stored data filter comprise: (i) one or more keywords describing an event, (ii) a description of a real location, (iii) a description of a virtual location, and (iv) a description of at least one action performed in response to detecting data matching the one or more keywords.

6. The computer-implemented method of claim 5, wherein the description of a real location comprises at least one of: (i) a street address, (ii) location coordinates, and (iii) a location name.

7. The computer-implemented method of claim 1, wherein the one or more actions comprise at least one of: (i) notifying a designated owner of the virtual property, (ii) creating an entry in a notification queue, and (iii) automatically modifying the virtual property to match the real property.

8. The computer-implemented method of claim 1, wherein performing one or more actions comprises displaying the at least one location of a virtual world along with at least one indicator intended to communicate the one or more events occurring in the real world to all users of the virtual world.

9. A computer-readable storage medium containing a program which, when executed by a processor, performs an operation, the operation comprising:
collecting, from at least one data source, data describing one or more events occurring in the physical world, wherein the at least one data source matches one or more predefined characteristics specified in a stored data filter;
determining, based on the collected data, at least one real location, of the physical world, affected by the one or more events; and
upon determining that at least one real location matches one or more predefined characteristics specified in a stored data filter:
identifying at least one location of a virtual world modeled according to the at least one real location; and
performing one or more actions to synchronize the at least one location of a virtual world with the at least one real location.

10. The computer-readable storage medium of claim 9, wherein performing one or more actions comprises:
determining, based on the collected data, one or more modifications to the at least one location of the virtual world required to match the at least one real location; and
performing the determined one or more modifications to the at least one location of the virtual world.

11. The computer-readable storage medium of claim 9, wherein the at least one data source comprises at least one of: (i) a web page, (ii) a news feed, and (iii) a database.

12. The computer-readable storage medium of claim 9, wherein determining that at least one real location matches one or more predefined characteristics specified in a stored data filter comprises matching words included in the collected data to one or more keywords specified in the stored data filter.

13. The computer-readable storage medium of claim 9, wherein the one or more predefined characteristics specified in a stored data filter comprise: (i) one or more keywords describing an event, (ii) a description of a real location, (iii) a description of a virtual location, and (iv) a description of at least one action performed in response to detecting data matching the one or more keywords.

14. The computer-readable storage medium of claim 13, wherein the description of a real location comprises at least one of: (i) a street address, (ii) location coordinates, and (iii) a location name.

15. The computer-readable storage medium of claim 9, wherein the one or more actions comprise at least one of: (i) notifying a designated owner of the virtual property, (ii) creating an entry in a notification queue, and (iii) automatically modifying the virtual property to match the real property.

16. The computer-readable storage medium of claim 9, wherein performing one or more actions comprises displaying the at least one location of a virtual world along with at least one indicator intended to communicate the one or more events occurring in the physical world to all users of the virtual world.

17. A system, comprising:
a processor; and
a memory containing a program, which when executed by the processor is configured to perform an operation, the operation comprising:
collecting, from at least one data source, data describing one or more events occurring in the physical world, wherein the at least one data source matches one or more predefined characteristics specified in a stored data filter;
determining, based on the collected data, at least one real location, of the physical world, affected by the one or more events; and
upon determining that at least one real location matches one or more predefined characteristics specified in a stored data filter:
identifying at least one location of a virtual world modeled according to the at least one real location; and
performing one or more actions to synchronize the at least one location of a virtual world with the at least one real location.

18. The system of claim 17, wherein performing one or more actions comprises:
determining, based on the collected data, one or more modifications to the at least one location of the virtual world required to match the at least one real location; and
performing the determined one or more modifications to the at least one location of the virtual world.

19. The system of claim 17, wherein the at least one data source comprises at least one of: (i) a web page, (ii) a news feed, and (iii) a database.

20. The system of claim 17, wherein determining that at least one real location matches one or more predefined characteristics specified in a stored data filter comprises matching words included in the collected data to one or more keywords specified in the stored data filter.
